(19) United States
(12) Patent Application Publication
(10) Pub. No.: US 2008/0082940 A1
(43) Pub. Date: Apr. 3, 2008

(54) Methods, systems, and computer program products for controlling presentation of a resource based on position or movement of a selector and presentable content

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/540,218

(22) Filed: Sep. 29, 2006

(51) Int. Cl. G06F 3/048

(52) U.S. Cl. 715/786; 715/784; 715/822; 715/856

(57) ABSTRACT

Methods, systems, and computer program products for controlling presentation of a resource based on position or movement of a selector and presentable content are disclosed. According to one method, input including movement of a selector in a view comprising a portion of presentable content of a resource being presented on a display device is detected. A distance between a selector position and at least one of a selectable entity in the presentable content and a position in the presentable content outside the view is determined. The presentable content is scrolled in response to detecting the input. At least one of a rate of the scrolling and a distance moved by the selector is controlled based on the determined distance.

### TECHNICAL FIELD

The subject matter described herein relates to controlling presentation of a resource. More particularly, the subject matter described herein relates to methods, systems, and computer program products for controlling presentation of a resource based on position or movement of a selector and presentable content.

### BACKGROUND

In order to allow users to interact with resources, such as documents, spreadsheets, web pages, and image files, the presentable area of a resource is often displayed on a display device. As used herein, the term “presentable content” refers to the entire portion of a resource that can be displayed on a display device. For example, for a document, the presentable content may be the entire content of the document as displayed by a word processor from the beginning to the end of the document.

The coordinate space for presenting the presentable content of a resource is referred to as a canvas. A canvas may be of variable size, depending on the limitations associated with the application that creates the canvas. In most applications, a canvas is two dimensional, but more than two dimensions can be supported. The terms “canvas” and “coordinate space” are used interchangeably herein.

The area of a canvas occupied by the presentable content of a document is referred to as the viewport. Presentable content is typically bounded, having a size and a reference coordinate from which the size and dimensions are measured. Often the reference coordinate is the top left corner or bottom left corner and is mapped to coordinate (0,0) of the canvas for two-dimensional content. Although viewports are typically rectangular, a viewport may take any shape. The terms “viewport” and “presentable content” are used interchangeably herein.

The portion of the viewport that is visible at one time to a user is referred to as a view. Like its containing viewport, a view has at least one reference coordinate from the viewport's canvas coordinate space and dimensions associated with the reference point. While typically rectangular, a view may take on any shape and is not required to have the same shape as its viewport. The terms “view” and “presentation space” are used interchangeably herein.

Because the viewport or area of a canvas occupied by presentable content may be larger than the view, it is desirable to allow a user to navigate through the presentable content in order to view the entire presentable content. One method for navigating through presentable content is scrolling. Conventionally, scrolling is controlled by moving a selector, such as a mouse pointer, over a scroll bar and clicking on the scroll tool on the scroll bar to control the scrolling. Alternatively, scrolling may be controlled by moving the cursor using the arrow keys on the keyboard.

One problem associated with conventional presentation of presentable content of resources is that repetitive motion input, such as keystrokes or mouse clicks, is required to control the scrolling. Such repetitive motion can be physically stressful and even damaging to the user. Another problem associated with conventional scrolling methods is that the rate of scrolling does not vary in accordance with information being displayed or the size of the presentable content. For example, it may be desirable to scroll faster through large documents and slower through small documents. In another example, it may be desirable to scroll slowly when in the proximity of a selectable element, such as a link. Because conventional scrolling methods lack such flexibility, there exists a need for methods, systems, and computer program products for controlling presentation of a resource based on position or movement of a selector and presentable content.

### SUMMARY

Methods, systems, and computer program products for controlling presentation of a resource based on position or movement of a selector and presentable content are disclosed. According to one method, input including movement of a selector in a view comprising a portion of presentable content of a resource being presented on a display device is detected. A distance between a selector position and at least one of a selectable entity in the presentable content and a position in the presentable content is determined. The position may be any location in the presentable content outside the view, such as a set of coordinates within the presentable content, but outside the view. For example, the set of coordinates may correspond to a boundary of an area occupied by the presentable content or a location separate from a boundary, such as a point in the center of the presentable content. The presentable content is scrolled in response to detecting the input. At least one of a rate of the scrolling and a distance moved by the selector is controlled based on the determined distance.

The subject matter described herein for controlling presentation of a resource based on movement of a selector and presentable content may be implemented using a computer program product comprising computer-executable instructions embodied in a computer-readable medium. Exemplary computer-readable media suitable for implementing the subject matter described herein include disk memory devices, chip memory devices, application specific integrated circuits, programmable logic devices, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary system for controlling presentation of a resource based on position or movement of a selector and presentable content size according to an embodiment of the subject matter described herein;

FIG. 2 is a flow chart illustrating an exemplary process for controlling presentation of a resource based on position or movement of a selector and presentable content according to an embodiment of the subject matter described herein;

FIG. 3 is a diagram illustrating exemplary presentable content and scrolling of the presentable content in a direction opposite movement of a selector according to an embodiment of the subject matter described herein;

FIG. 4 is a flow chart illustrating an exemplary process for scrolling presentable content opposite a direction of movement of a selector according to an embodiment of the subject matter described herein;

FIG. 5 is a diagram illustrating exemplary presentable content and scrolling of the presentable content in a direction substantially orthogonal to a direction of movement of a selector according to an embodiment of the subject matter described herein; and

FIG. 6 is a flow chart illustrating an exemplary process for scrolling presentable content in a direction substantially orthogonal to a direction of movement of a selector according to an embodiment of the subject matter described herein.

### DETAILED DESCRIPTION

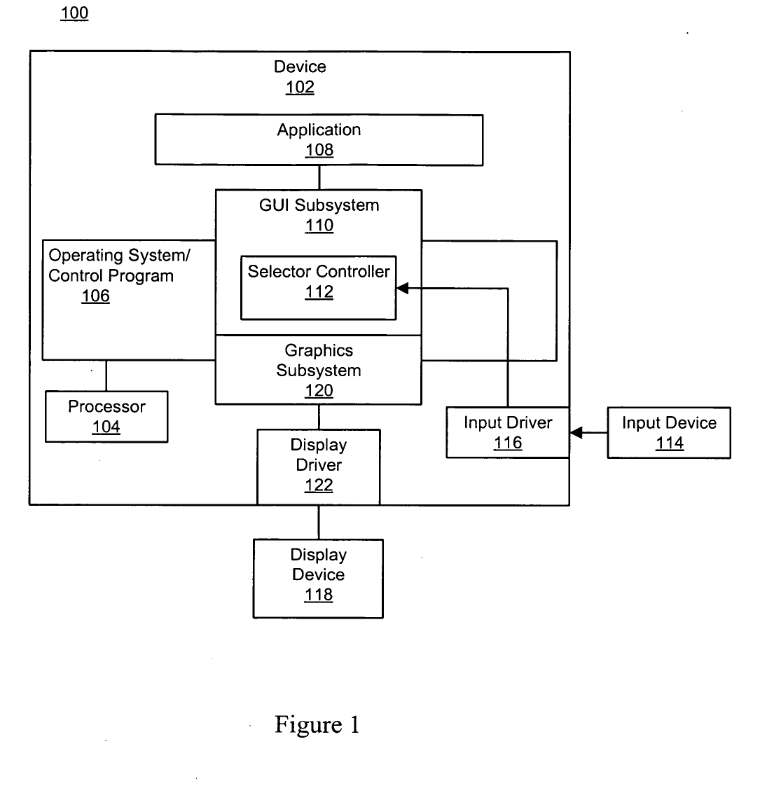

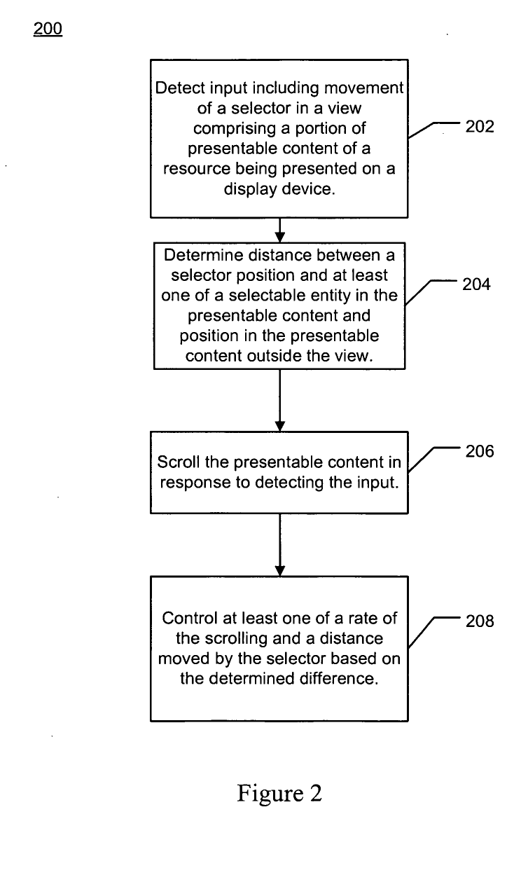

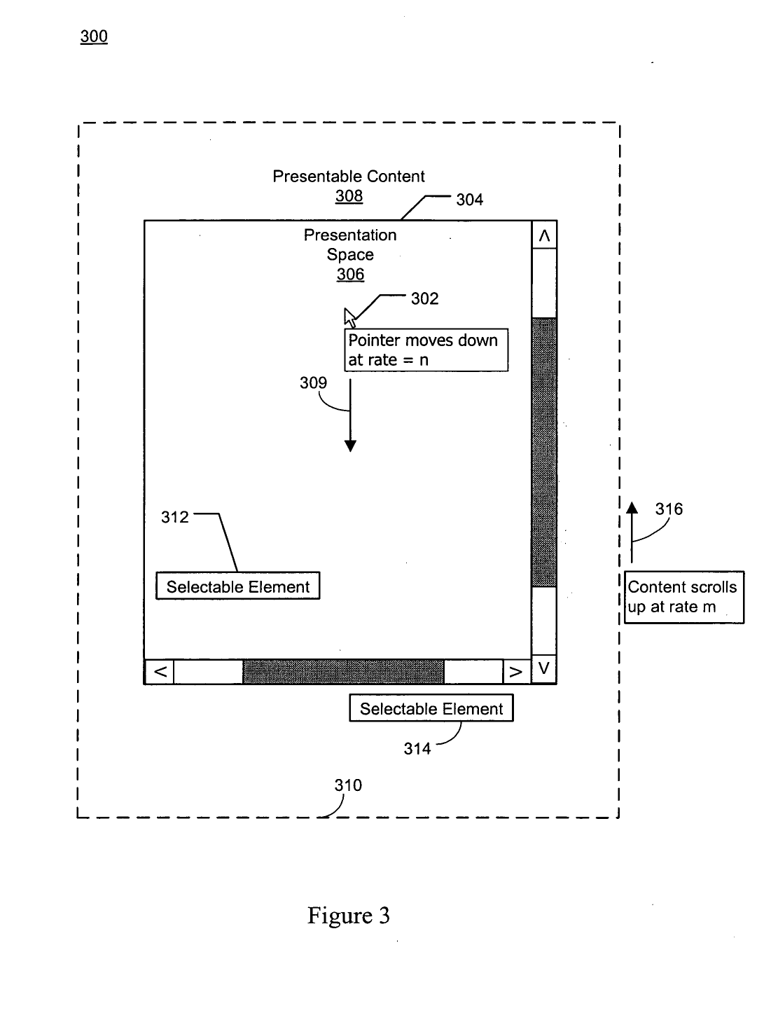

According to one aspect, the subject matter described herein includes a system for controlling presentation of a resource based on position or movement of a selector and presentable content. FIG. 1 is a block diagram illustrating an example of such a system. Referring to FIG. 1, system 100 may be embodied in a device 102 including a processor 104 and an operating system 106 or an analogous control program and associated hardware, drivers and subsystems for allowing execution of software, such as application 108. System 100 further includes a GUI subsystem 110 for enabling software, such as application 108, to present graphical user interfaces. GUI subsystem 110 includes selector controller 112 for monitoring various supported selector inputs including, for example, pointing selectors such as a mouse, and keyboard selectors such as a tab key. The operation of these and the remaining components depicted in FIG. 1 are described in conjunction with FIGS. 2 and 3.

FIG. 2 is a flow chart illustrating an exemplary method or process 200 for controlling presentation of a resource based on presentable content size and or elements according to an embodiment of the subject matter described herein. The method can be carried out using the exemplary system 100 depicted in FIG. 1 and illustrated using exemplary canvas 300 depicted in FIG. 3, portions of which are referenced below for illustrative purposes.

Referring to FIG. 2, in block 202, input is detected including the movement of a selector. The selector movement is detected within a view comprising a portion of the presentation content being presented by a display device. For example, in system 100 user manipulation of input device 114 causes input device 114 to send a signal including manipulation information to input driver 116. Input driver 116 generates a message based on the received manipulation information, which is received by selector controller 112 via operating system 106 in this example. Input device 114 may include a mouse, a track point, a pen device, or a direction key, for example. The input received can include a combination of input devices, for example, by holding down a key and moving a mouse.

FIG. 3 illustrates exemplary canvas 300 associated with application 108. Mouse pointer 302 is an exemplary visual representation of the selector in block 202 of method 200 as displayed in GUI pane 304, which creates a view or presentation space 306 of a portion of presentable content 308. At least a portion of presentation space 306 within GUI pane 304 is visible on some or the entire display area of display device 118. For example, GUI pane 304 may be a window in a WINDOWS® operating system desktop environment that takes up less than all the display area, substantially the entire display area (full screen), or more than the display area (such as for multi-display arrangement). In any case, a portion of presentable content 308 is not visible in the GUI pane 304.

Arrow 309 pointing towards the bottom of canvas 300 in FIG. 3 indicates the visible movement on display device 118 of mouse pointer 302 corresponding to the detected input of input device 114 in GUI pane 304. The visible movement of mouse pointer 302 in this example occurs when selector controller 112 associates manipulation information in the received message from input driver 116 with a representation (not shown) of mouse pointer 302 managed by GUI subsystem 110.

GUI subsystem 110 interprets the manipulation information communicated from selector controller 112 as including movement information associated with the representation of mouse pointer 302. GUI subsystem 110 directs graphics subsystem 120 to alter its representation of canvas 300 including the position of mouse pointer 302. Graphics subsystem 120 carries out the directions by, for example, altering the content of one or more display buffers (not shown) associated with the content of canvas 300. Graphics subsystem 120 activates at least an altered portion of the display buffer(s) by providing display buffer content information to display driver 122. Display driver 122 causes display device 118 to refresh using at least the activated portion of the display buffer(s) making the movement of mouse pointer 302 visible.

In block 204, in FIG. 2 a distance between a selector position and at least one of a selectable entity in the presentable content and a position in the presentable content outside the view is determined. The position in the presentable content may be any location in the presentable content outside the view, for example, a location defined by a set of one or more coordinates. The position may correspond to a boundary of an area occupied by the presentable content, such as a top boundary, a bottom boundary, a left boundary, or a right boundary. Alternatively, the position may correspond to a location separate from a boundary of an area occupied by the presentable content, such as any location somewhere inside the boundaries of the presentable content that is outside the view.

In FIG. 3, mouse pointer 302 has associated positions at the time an input is detected in block 202 and thereafter during mouse pointer 302 movement associated with the input. In this example, GUI subsystem 110 determines the distance between mouse pointer 302 and boundary 310 of presentable content 308 at the time it receives movement information from selector controller 112 as described earlier. In this example, GUI subsystem 120 determines the distance between mouse pointer 302 and boundary 310 of presentable content 308 each time it directs graphics subsystem 120 to update at least a portion of its representation of canvas 300. The distance, in this example, may be calculated in terms of a coordinate system associated with canvas 300.

Additionally, in this example, GUI subsystem 110 manages selectable entities, such as selectable elements 312 and 314, including managing their locations within presentable content 308. GUI subsystem 110 in this example determines the distance between mouse pointer 302 and at least one selectable entity in the direction of movement of mouse pointer 302 in a manner analogous to the manner distances are determined between mouse pointer 302 and boundary 310 of presentable content 308 as previously described. In this example, the distance between selectable element 312 closest to selector 302 in the direction of movement is used. The distance, for example, is calculated to a line orthogonal to the direction of movement running through a point in the selectable entity determined by GUI subsystem 110. In this example, a direction of selector movement is translated to either a horizontal or vertical movement in the presentation space 306 based on whether the movement more closely approximates a horizontal or a vertical movement.

In block 206 of FIG. 2, the presentable content is scrolled in response to detecting the input in block 202. In block 208, at least one of a rate of the scrolling and a distance move by the selector is controlled based on the distance determined in block 204. For example, in one embodiment, if the representation of presentable content 308 is determined to be relatively large by GUI subsystem 110 and the distance used is the distance between mouse pointer 302 and boundary 310 of presentable content 308 in the direction of movement of the selector, GUI subsystem 110 directs graphics subsystem 120 to scroll presentable content 308 faster and move mouse pointer 302 more slowly in the direction opposite the movement of the detected input. Thus, an application with a longer presentable content than a second application will scroll faster with the movement of mouse pointer 302 relatively less responsive to manipulation of input device 114 than the application with relatively shorter presentable content. Analogous statements can be made concerning presentable content areas with differing horizontal sizes, or, in fact, any dimension given a scrolling direction supported by an application.

Some embodiments may use the calculated distance to affect only the rate of scrolling, so that the further a selector is from a boundary, selectable entity, or a point outside the view, the faster scrolling occurs. Other embodiments may use the calculated distance to affect only the rate of movement of a selector. Thus, selector of an application with a relatively larger presentable content area in a specified direction of movement will move less rapidly across its presentation space than a selector of an application with a relatively smaller presentable content area in the same direction of movement.

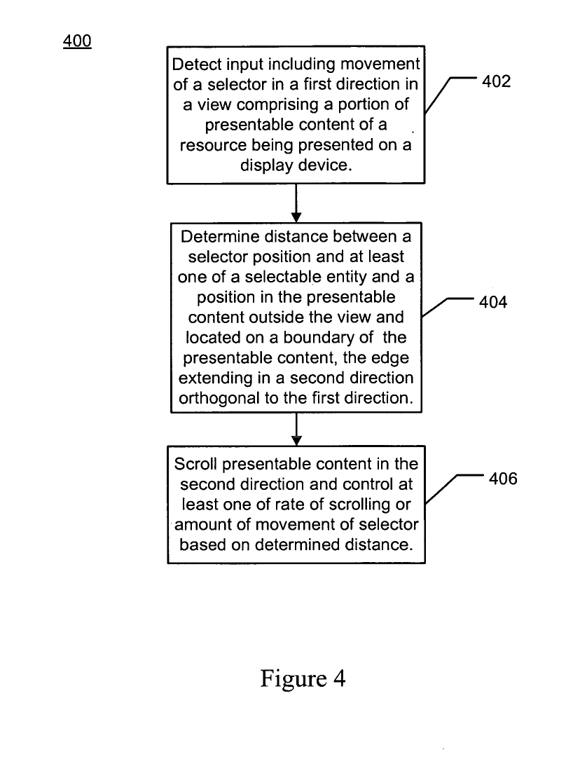

FIG. 4 is a flow chart illustrating in more detail a process for controlling presentation of a resource based on position or movement of a selector and presentable content according to an embodiment of the subject matter described herein. Referring to FIG. 4, in block 402, input including movement of a selector in a first direction in a view comprising a portion of presentable content of a resource being presented on a display device is detected. In block 404, a distance between a selector position and at least one of a selectable entity in the presentable content and a position in the presentable content outside the view is determined, such as a point that corresponds to a boundary of the presentable content. The boundary may extend in a second direction orthogonal to the first direction. For example, referring to FIG. 3, pointer 302 may move in the direction corresponding to arrow 309. The distance between a position of pointer 302 and a boundary 310 of presentable content 308 may be determined.

In block 406, the presentable content is scrolled in a second direction substantially opposite the first direction in response to detection of the input. At least one of a rate of the scrolling in a distance moved by the selector may be based on the determined distance. In FIG. 3, because pointer 302 moves down corresponding to arrow 309, scrolling may occur upwards in the direction of arrow 316.

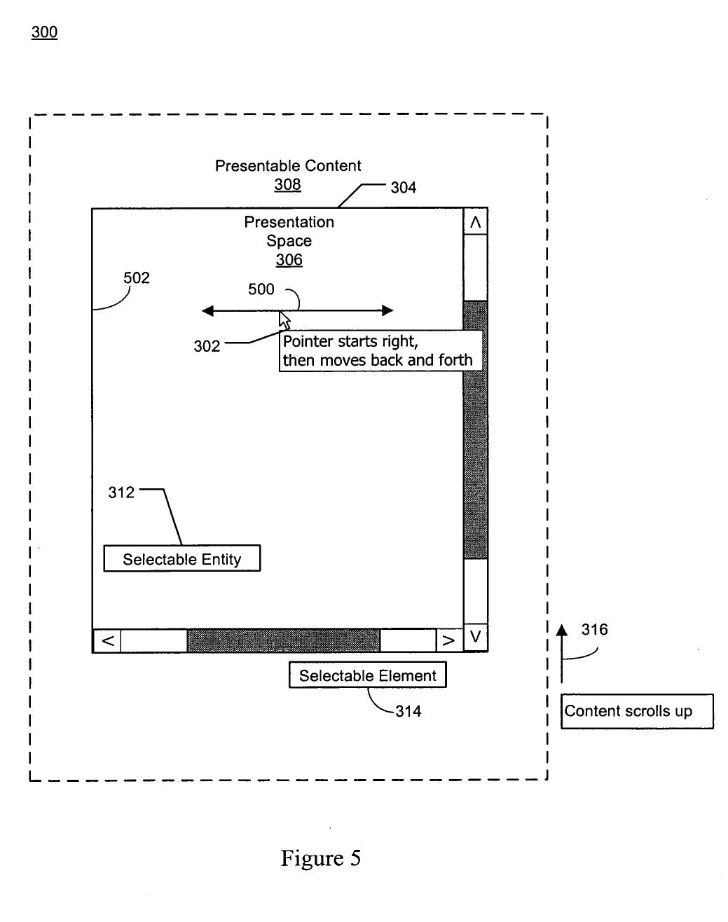

In FIG. 3, scrolling occurs in a direction that is parallel to but opposite the direction of a movement of the selector. In an alternate implementation, scrolling may occur in a direction that is angularly offset from, such as orthogonal to, a direction of movement of a selector. FIG. 5 is a diagram illustrating an example where scrolling occurs in a direction substantially orthogonal to a direction of movement of a selector according to an embodiment of the subject matter described herein. Referring to FIG. 5, an exemplary canvas 300 associated with application 108 is illustrated.

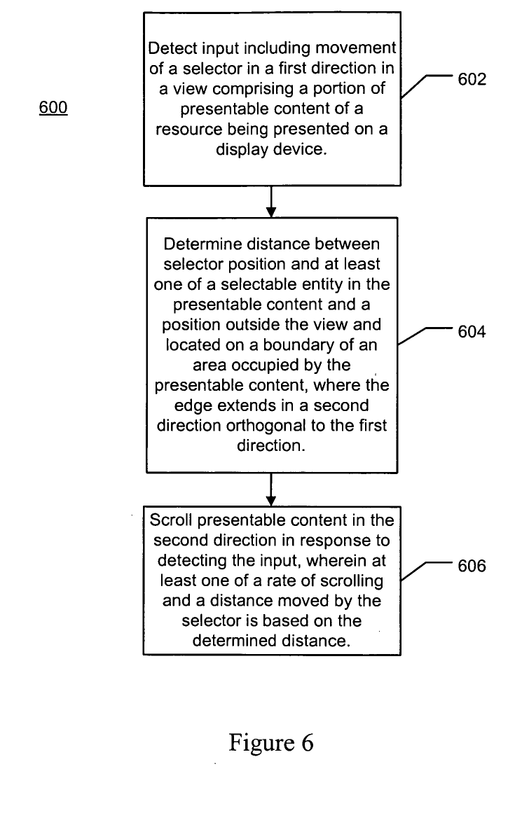

Double-ended horizontal arrow 500 shows the direction(s) of movement of the mouse pointer 302. A user manipulates input device 114 such that mouse pointer 302 moves right-to-left, then left-to-right in the presentation space 306 on display device 118. In this example, the initial direction of movement determines the direction of scrolling. That is, if the initial movement of mouse pointer 302 is left-to-right, then presentable content 308 is scrolled up as indicated by single-ended arrow 316 in FIG. 5. Scrolling up continues as long as mouse pointer 302 moves back and forth-across presentable content 308 in a substantially continuous manner. Similarly, if the initial movement of mouse pointer 302 is from right-to-left, then presentable content 308 is scrolled down. Scrolling down continues as long as mouse pointer 302 moves back and forth across presentation space 306 in a substantially continuous manner. It can be seen that the relationships among the direction of initial movement and the direction of scrolling may be reversed in an alternate embodiment. Some embodiments may allow the relationships to be configurable. Further, some embodiments may support both variations of the exemplary embodiment associated with method 400 and variations of the exemplary embodiment associated with method 600 illustrated in FIG. 6. The method used may be a configuration option or may be activated by selection of an associated key sequence or other input.

FIG. 6 is a flow chart illustrating an exemplary process for scrolling presentable content in a direction substantially orthogonal to a direction of a movement of a selector according to an embodiment of the subject matter described herein. Referring to FIG. 6, in block 602, input including movement of a selector in a first direction in a view comprising a portion of presentable content of a resource being presented on a display device is detected. In block 604, a distance between a selector position and at least one of a selectable entity in the presentable content and a position in an area occupied by the presentable content outside the view is determined. For example, the position may be located on a boundary of an area occupied by the presentable content. The boundary may extend in a second direction orthogonal to the first direction. In FIG. 5, a distance between a position of selector 302 along arrow 500 and boundary 502 may be determined.

In block 606, the presentable content is scrolled in the second direction in response to detecting the input, where at least one of a rate of the scrolling and a distance moved by the selector is based on the determined distance. For example, in FIG. 5, as selector 302 moves along arrow 500, selectable content may scroll up as indicated by arrow 316 or down, in a direction opposite to arrow 316.

In one enhancement of the subject matter described herein, a rate of scrolling and/or movement of a selector may be proportional to a determined distance in a substantially continuous manner as described. Alternately, rate changes may occur at specified absolute distances (at least one). Further, rate changes may be associated with specified ratios of distance to overall presentable content size. In short, rate change may be calculated in a continuous manner using any distances from a selector to any combination of boundaries or other positions in the presentable content and in combination with a distance (one or more) to a boundary of a presentation space. For example, the rate of scrolling and/or movement of the selector may be controlled in a continuous or stepwise manner based on the determined distance. In one implementation, GUI subsystem 110 may repeatedly determine the distance between the selector and a boundary of the presentable content, and graphics subsystem 120 may vary the rate of scrolling and/or movement of the selector in a continuous or stepwise manner.

According to another enhancement of the subject matter described herein, a dimension of the presentable content area, a dimension between two or more selectable entities, and/or a dimension between a selectable entity and a boundary of the presentable content area and/or presentation space may be used to control a rate of scrolling and/or movement of the selector. That is, when a distance from the selector to a boundary and a distance to an opposite boundary are used to determine a rate, a size of the document in a line intersecting both boundaries, is, in effect, being used to control the rate.

According to another enhancement of the subject matter described herein, scrolling and or the distance moved by the selector may be controlled based on movement of the selector in a predetermined pattern, such as an arc or a circle. For example, if the user moves a selector in a circular pattern, the rate of scrolling may be controlled based on the size of the circle. In addition, the direction of scrolling may be controlled based on the direction of the circular motion. Circular motion in a clockwise direction may cause the graphics subsystem to invoke scrolling in one direction, and circular motion in a counter clockwise direction may cause the graphics subsystem to effect scrolling in the opposite direction.

According to another aspect of the subject matter described herein, the rate of scrolling the boundary of the presentable content in the presentation space may be set such that the scrolling to the boundary in the presentation space occurs within a fixed time period. The fixed time period may be independent of the distance between the boundary of the presentable content and the current location of the view or presentation space.

The subject matter described herein for controlling presentation of a resource based on presentable content may be used with any application that displays resources in a visual manner. Examples of applications in which the subject matter described herein may be used include word processors, image processors, web browsers, spreadsheets, or any other application where scrolling is used to view the presentable content.

A system for controlling presentation of a resource based on movement of a selector and presentable content may include means for detecting input including movement of a selector in a view comprising a portion of presentable content of a resource being presented on a display device. For example, selector controller 112 illustrated in FIG. 1 may detect movement of a mouse pointer or a cursor while presentable content of a file is being displayed on a computer display device. The system may further include means for determining a distance between a selector position and at least one of a selectable entity in the presentable content and a position in the presentable content outside the view. For example, GUI subsystem 110 illustrated in FIG. 1 may determine the distance between a position of the selector and either a selectable entity, such as a link, in the presentable content, or a position, such as a boundary or other point, in the presentable content. The system may further include means for scrolling the presentable content in response to detecting the input. For example, GUI subsystem 110 may direct graphics subsystem 120 to scroll the presentable content when movement of the mouse pointer or cursor is detected. The system may further include means for controlling at least one of a rate of the scrolling and a distance moved by the selector based on the determined distance. For example, graphics subsystem 120 may control the rate of scrolling or the amount by which the selector moves based on the determined distance.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for controlling presentation of a resource based on movement of a selector and presentable content, the method comprising:
detecting input including movement of a selector in a view comprising a portion of presentable content of a resource being presented on a display device;
determining a distance between a selector position and at least one of a selectable entity in the presentable content and a position in the presentable content outside the view;
scrolling the presentable content in response to detecting the input; and
controlling at least one of a rate of the scrolling and a distance moved by the selector based on the determined distance.

2. The method of claim 1 wherein the selector comprises at least one of a mouse pointer and a cursor.

3. The method of claim 1 wherein determining a distance between a selector position and at least one of a selectable entity in the presentable content and a position in the presentable content outside the view includes determining a distance between the selector position and a boundary of the presentable content outside the view.

4. The method of claim 1 wherein controlling at least one of a rate of the scrolling and a distance moved by the selector includes controlling at least one of the rate of the scrolling, the distance moved by the selector, and a direction of the scrolling based on a gesture associated with the selector.

5. The method of claim 4 wherein the gesture comprises a circular motion of the selector and wherein controlling at least one of a rate of the scrolling and a distance moved by the selector includes controlling the rate of the scrolling based on a size of an associated circle.

6. The method of claim 4 wherein the gesture comprises a circular motion of the selector and wherein controlling at least one of a rate of the scrolling and a distance moved by the selector includes controlling a direction of the scrolling based on a direction of the circular motion.

7. The method of claim 4 wherein the gesture comprises movement of the selector in a first direction and wherein the method further comprises associating a predetermined direction of the scrolling with the first direction.

8. The method of claim 1 wherein scrolling the presentable content includes scrolling the presentable content in a direction parallel to a direction of the movement of the selector.

9. The method of claim 1 wherein scrolling the presentable content includes scrolling the presentable content in a direction that is angularly offset from a direction of the movement of the selector.

10. The method of claim 9 wherein scrolling the presentable content in a direction that is angularly offset from the direction of movement of the selector includes scrolling the presentable content in a direction that is substantially orthogonal to the direction of movement of the selector

11. The method of claim 1 wherein the distance is repeatedly determined and wherein controlling at least one of a rate of the scrolling and a distance moved by the selector includes continuously varying the rate of the scrolling based on the determined distance.

12. The method of claim 1 wherein controlling at least one of a rate of the scrolling and a distance moved by the selector includes varying the rate of the scrolling in a stepwise manner based on the determined distance.

13. The method of claim 1 wherein controlling at least one of a rate of the scrolling and a distance moved by the selector includes decreasing the rate of the scrolling when the selector is in the proximity of a selectable element in the presentable content.

14. A system for controlling presentation of a resource based on movement of a selector and presentable content, the system comprising:
a selector controller for detecting input including movement of a selector in a view comprising a portion of presentable content of a resource being presented on a display device;
a graphical user interface (GUI) subsystem for determining a distance between a selector position and at least one of a selectable entity in the presentable content and a position in the presentable content outside the view; and
a graphics subsystem associated with the GUI subsystem for scrolling the presentable content in response to the detection of the input by the selector controller and for controlling at least one of a rate of the scrolling and a distance moved by the selector based on the determined distance.

15. The system of claim 14 wherein the selector comprises at least one of a mouse pointer and a cursor.

16. The system of claim 14 wherein the GUI subsystem is adapted to determine a distance between the selector position and a boundary of the presentable content outside the view.

17. The system of claim 14 wherein the graphics subsystem is adapted to control at least one of the rate of the scrolling, the distance moved by the selector, and a direction of the scrolling based on a gesture associated with the selector.

18. The system of claim 17 wherein the gesture comprises a circular motion of the selector and wherein the graphics subsystem is adapted to control the rate of the scrolling based on a size of an associated circle.

19. The system of claim 17 wherein the gesture comprises a circular motion of the selector and wherein the graphics subsystem is adapted to control the direction of the scrolling based on a direction of the circular motion.

20. The system of claim 17 wherein the gesture comprises movement of the selector in a first direction and wherein the graphics subsystem is adapted to associate a predetermined direction of the scrolling with the first direction.

21. The system of claim 14 wherein the graphics subsystem is adapted to scroll the presentable content in a direction parallel to a direction of the movement of the selector.

22. The system of claim 14 wherein the graphics subsystem is adapted to scroll the presentable content in a direction that is angularly offset from a direction of the movement of the selector.

23. The system of claim 22 wherein the graphics subsystem is adapted to scroll the presentable content that is substantially orthogonal to the direction of movement of the selector.

24. The system of claim 14 wherein the GUI subsystem is adapted to repeatedly determine distance is repeatedly determined and wherein the graphics subsystem is adapted to continuously vary the rate of scrolling on the determined distance.

25. The system of claim 14 wherein the GUI subsystem is adapted to repeatedly determine the distance and wherein the graphics subsystem is adapted to vary the rate of the scrolling in a stepwise manner based on the determined distance.

26. The system of claim 14 wherein the graphics subsystem is adapted to decrease the rate of the scrolling is decreased when the selector is in the proximity of a selectable element in the presentable content.

27. A system for controlling presentation of a resource based on movement of a selector and presentable content, the system comprising:
means for detecting input including movement of a selector in a view comprising a portion of presentable content of a resource being presented on a display device;
means for determining a distance between a selector position and at least one of a selectable entity in the presentable content and a position in the presentable content outside the view;
means for scrolling the presentable content in response to detecting the input; and
means for controlling at least one of a rate of the scrolling and a distance moved by the selector based on the determined distance.

28. A computer program product comprising computer-executable instructions embodied in a computer-readable medium for performing steps comprising:
detecting input including movement of a selector in a view comprising a portion of presentable content of a resource being presented on a display device;
determining a distance between a selector position and at least one of a selectable entity in the presentable content and a position in the presentable content outside the view;
scrolling the presentable content in response to detecting the input; and
controlling at least one of a rate of the scrolling and a distance moved by the selector based on the determined distance.
